(19) United States
(12) Patent Application Publication
(10) Pub. No.: US 2013/0262687 A1
(43) Pub. Date: Oct. 3, 2013

(54) CONNECTING A MOBILE DEVICE AS A REMOTE CONTROL

(71) Applicants: Ryan L. Avery, San Francisco, CA (US); Oliver Strimpel, Manchester, MA (US)

(72) Inventors: Ryan L. Avery, San Francisco, CA (US); Oliver Strimpel, Manchester, MA (US)

(21) Appl. No.: 13/434,241

(22) Filed: Mar. 29, 2012

(51) Int. Cl. G06F 15/16

(52) U.S. Cl. 709/229; 709/227

(57) ABSTRACT

Methods and systems for connecting a mobile device to a host machine cause the mobile device to act as a remote control for an application running on the host machine. When a user requests a connection, the host application generates an access key, transmits it to a web server, outputs a representation of the key, transitions to listening mode, and receives a connection request from the mobile device via the web server. The mobile device gains access to the web server by capturing the representation of the access key output by the host machine, and extracting the key from the captured representation, presenting the key to the web server. When the host application receives via the web server the request from the mobile device to connect to the computer, a connection between the computer and the mobile device via the web server is established.

### BACKGROUND

Many computer-implemented applications running on a host machine are controlled by means of a graphical user interface (GUI). The interface is often displayed on a monitor of the host machine, and can be controlled with a mouse or other pointing device, or in the case of a touch screen, with a finger. This arrangement may not be adequate for some applications. For example, in complex applications with many user-controllable features, numerous controls need to be packed into a finite amount of screen real estate, which can result in a crowded and confusing GUI. Various approaches have been adopted to remedy this problem. In one, a top level GUI limited to showing high level functions is displayed. When the user selects a particular function, a window having a set of controls specifically directed to the selected function is displayed. In another approach, the amount of available screen real estate is increased by distributing the GUI over multiple monitors attached to the host machine.

The problem of an overcrowded GUI is especially acute in the case of media editing systems, which continue to evolve by expanding the number and scope of features offered to users. For example, in a digital audio workstation, users can interact with transport, track volume, pan, mute, solo controls, as well as many other operations, such as save and undo. Each group of controls is located in a different part of the user interface, and as the number of control groups increases, the result is an increasingly crowded interface. Interacting with all these elements with a mouse or touch screen can be frustrating for the user because some of the functions need to be relegated to small buttons, which require precise movements to hover over and select.

For some applications it is desirable to enable a user to control an application without requiring the user to be co-located with a main host monitor and host input device. This may be achieved, for example, by enabling the user to control an aspect of the application using a remote device such as a tablet. Referring again to media composition applications, for all but the simplest of projects, media composition workflows usually involve several different people playing different roles. Not all the roles require the full media editing functionality. For example, when a producer needs to review the script of a video composition, it may be sufficient to provide text viewing and editing functionality without video editing, or even, in some cases, video viewing capability. A system that enables a second person to control an aspect of a media composition application using a wirelessly connected tablet is described in U.S. patent application Ser. No. 13/102,458, entitled “Context-Sensitive Mobile Controller for Media Editing Systems.” filed on May 6, 2011, which is hereby incorporated by reference.

There is a need to support workflows involving the use of remote devices that are used to control an aspect of a host application.

### SUMMARY

In general, the methods, systems, and computer program products described herein enable a host application to be readily connected to a remote device that can then be used as a remote controller for the application. Making the connection involves the exchange of an access key between the host computer and the remote device.

In general, in one aspect, a method of connecting a mobile device to a host application running on a host computer includes: in response to receiving a request from a user of the host application to connect the host application to the mobile device: causing the host application to generate an access key, transmit the access key to a web server in data communication with the host computer, output a representation of the access key on an output device of the host computer, and transition to a listening mode; enabling the host application to receive via the web server a request from the mobile device to connect to the host application, wherein the mobile device gains access to the web server by: capturing the representation of the access key from the output device, extracting the access key from the captured representation of the access key, and presenting the access key to the web server; and in response to receiving via the web server the request from the mobile device to connect to the host application, establishing a connection between the host application and the mobile device via the web server.

Various embodiments include one or more of the following features, Receiving at the host computer via the connection identification information for a user of the mobile device and, if the identification information does not correspond to an authorized mobile device user, closing the connection between the computer and the mobile device. The output device is a display screen and capturing the representation of the access key includes capturing an image of the display screen using a camera in the mobile device. The key is displayed as a QR code, and the key is extracted by a QR code reader application on the mobile device. The key is dynamically generated by the host computer. The host computer hosts an application and sends over the connection from the host computer to the mobile device information that enables the mobile device to act as a remote control device for the application. The application is a time-based media editing application, and enabling the mobile device to act as a remote control device includes enabling the mobile device to act as at least one of transport controls, a mixer, a user interface for a plug-in to the time-based media composition application, and a user interface for controlling parameters of a time-based media composition. The parameters of the time-based media composition include audio track volume, audio track pan, audio track I/O routing, and an application status panel. When the mobile device acts as a remote control device, control information is sent over the connection from the mobile device to the application and status information is sent from the application to the mobile device. The web server is hosted by the host computer, and the connection between the host computer and the mobile device is a wireless connection. The output device is an audio output device, and capturing the representation of the access key includes using a microphone in the mobile device to capture audio that is output by the audio output device. The representation of the access key is embedded as a watermark signal in the audio that is output by the audio output device.

In general, in another aspect, a method of connecting a mobile device to a host application running on a host computer includes: capturing on the mobile device a representation of an access key from an output device of the host computer, wherein, in response to the host application receiving a request from a user of the host application to connect the mobile device to the host application, the host application generates the access key, transmits the access key to a web server in data communication with the host computer, and outputs the representation of the access key on the output device of the host computer; using the mobile device to extract the access key from the captured representation of the access key, access the web server by presenting the access key to the web server, and request a connection to the host application via the web server; and connecting the mobile device to the host application via the web server, wherein the host application establishes a connection with the mobile device in response to receiving via the web server the request from the mobile device to connect to the host application.

In general, in a further aspect, a computer program product comprises: a computer-readable medium with computer program instructions encoded thereon, wherein the computer program instructions, when executed by a host computer, instruct the host computer to perform a method of connecting a mobile device to a host application running on the host computer, the method including: in response to receiving a request from, a user of the host application to connect the host application to the mobile device, causing the host application to generate an access key, transmit the access key to a web server in data communication with the host computer, output a representation of the access key on an output device of the host computer, and transition to a listening mode; enabling the host application to receive via the web server, a request from the mobile device to connect to the host application, wherein the mobile device gains access to the web server by capturing the representation of the access key from the output device, extracting the access key from the captured representation of the access key, and presenting the access key to the web server; and in response to receiving via the web server the request from the mobile device to connect to the host application, establishing a connection between the host application and the mobile device via the web server.

In general, in a still further aspect a computer system comprises: an output device; a memory for storing computer-readable instructions for executing a host application; and a processor in data communication with the output device and with the memory, wherein the processor, when executing the computer-readable instructions, causes the host application to respond to receiving a request from a user of the host application to connect the host application to a mobile device by: generating an access key, transmitting the access key to a web server in data communication with the host computer, outputting a representation of the access key on an output device of the host computer, transitioning to a listening mode, enabling the host application to receive via the web server, a request from the mobile device to connect to the host application, wherein the mobile device gains access to the web server by: capturing the representation of the access key from the output device, extracting the access key from the captured representation of the access key, and presenting the access key to the web server; and in response to receiving via the web server the request from the mobile device to connect to the host application, establishing a connection between the host application and the mobile device via the web server.

Various embodiments include one or more of the following features. The host application is a time-based media editing application. The output device is a display screen and the access key is graphically encoded. The access key is encoded as a QR code. Using the connection between the host application and the mobile device to transmit information from the host application to the mobile device, wherein the information includes instructions that, when executed on the mobile device, cause the mobile device to act as a remote user interface for the host application. The output device is an audio output device, and the access key is acoustically encoded.

### BRIEF DESCRIPTION OF THE DRAWINGS

FIG. 1 is high level flow diagram illustrating the steps involved in connecting a mobile device to a host application as a remote user interface.

FIG. 2 is a diagrammatic representation of host application user interface for initiating a connection to a remote user interface.

FIG. 3 is a diagrammatic representation of a screen shot of a host application displaying a QR code.

FIG. 4 is an illustration of a mobile device using a QR code scanning application to detect a QR code displayed by a host application.

FIG. 5 is an illustration of the mobile device of FIG. 4 after the QR code displayed by the host application is detected.

FIG. 6 is a diagrammatic representation of a screen shot of the host application notifying a user that a connection to a remote user interface has been established.

FIG. 7 is an illustration of a mobile device of FIG. 4 providing remote audio mixer controls for a digital audio workstation.

FIG. 8A is a block diagram representing a connection of a mobile device to the host application via a remote web server.

FIG. 8B is a block diagram representing a connection of a mobile device to the host application via a local web server associated with the host application.

FIG. 9 is an illustration a remote user interface for audio channel controls.

FIG. 10 is an illustration of a remote user interface for audio transport controls.

FIG. 11 is an illustration of a remote user interface for controls for a compressor-limiter plug-in.

FIG. 12 is an illustration of a remote user interface for displaying a bin window for a video composition project.

FIG. 13 is an illustration of a remote user interface for color controls for a video composition project.

FIG. 14 is an illustration of a remote user interface showing a timeline in trim mode for a video composition project.

FIG. 15 is an illustration of a remote user interface showing a script view and search controls for a video composition project.

### DETAILED DESCRIPTION

The use of a mobile device to control an application running on a remote host machine can serve a number of purposes. Two such purposes are described above in the background section: to help reduce crowding and confusion in a complex user interface; and to facilitate multi-person workflows. With the increasing popularity of wireless devices such as smart phones and tablets, and the improvement in quality and ease of use of their input/output capabilities, the use of such devices as remote controllers is growing. However in current systems it can be a laborious and error-prone process to set up a wireless device as a remote controller with bidirectional communication with the host application. Additional steps that may not be straightforward include downloading and installing the remote controller software on the wireless device.

These problems are addressed by a process that partially automates the steps of connecting the device to be used as a remote controller to the host application, and downloading and installing the remote control software to the device.

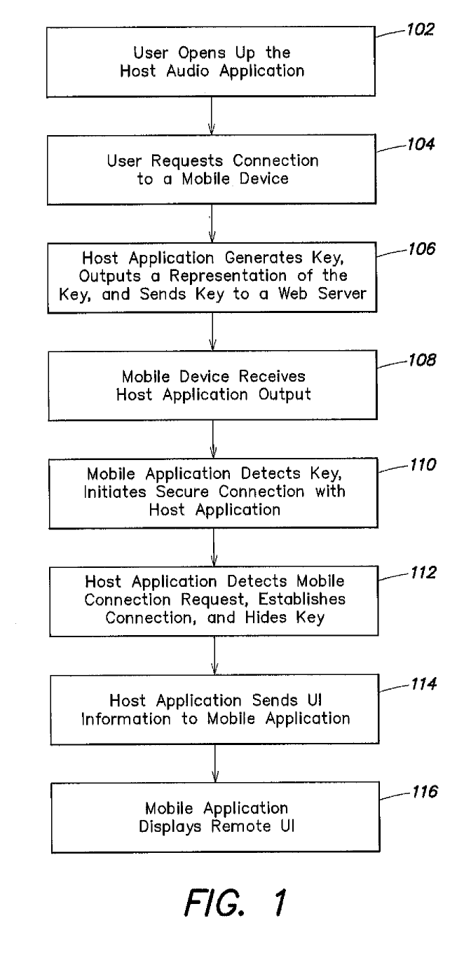

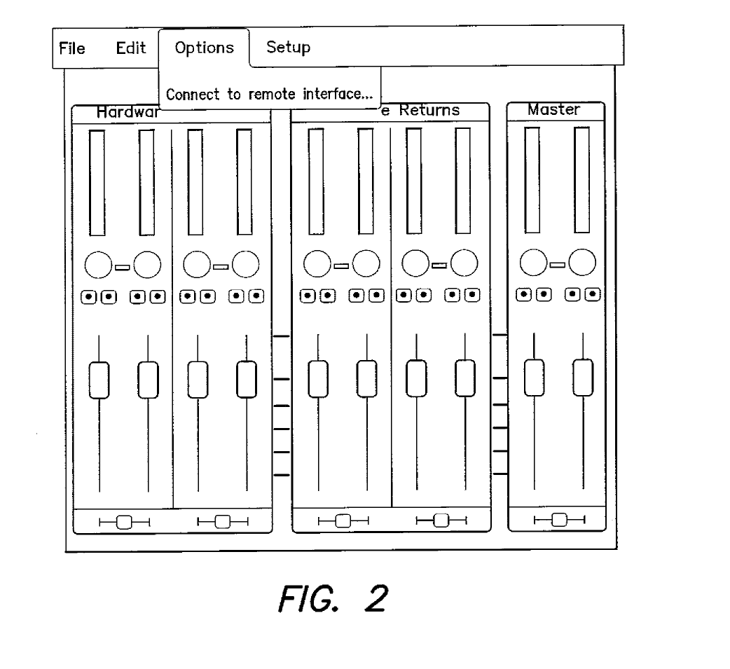

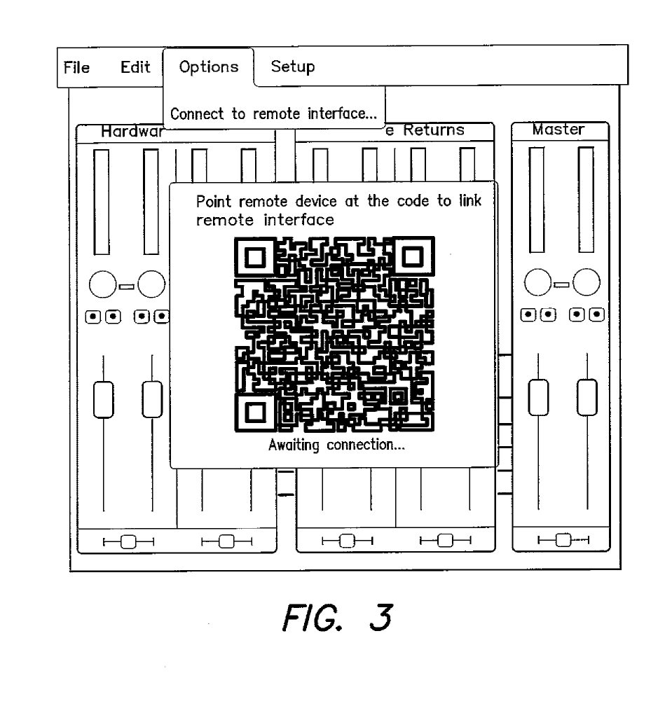

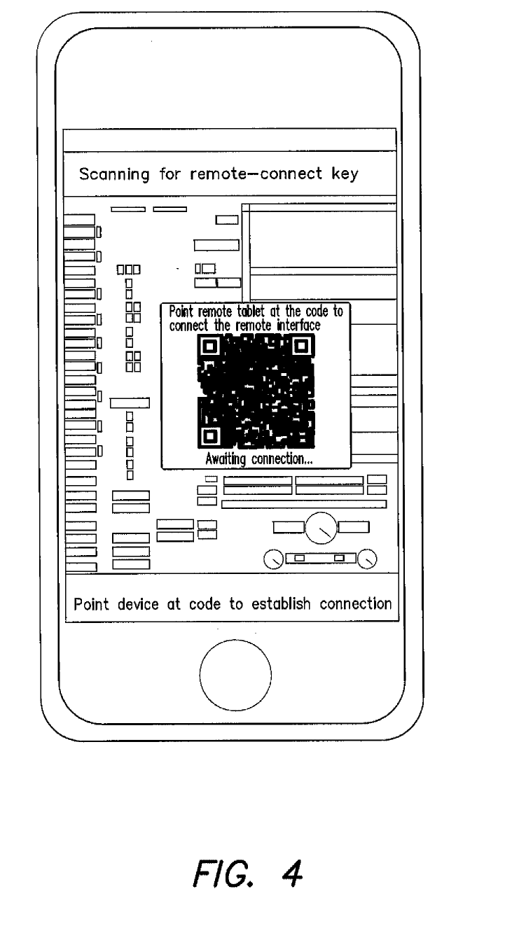

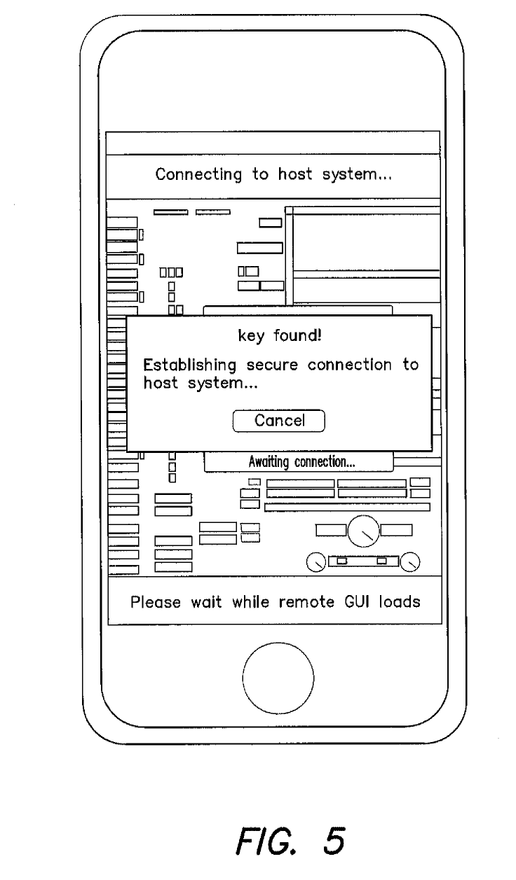

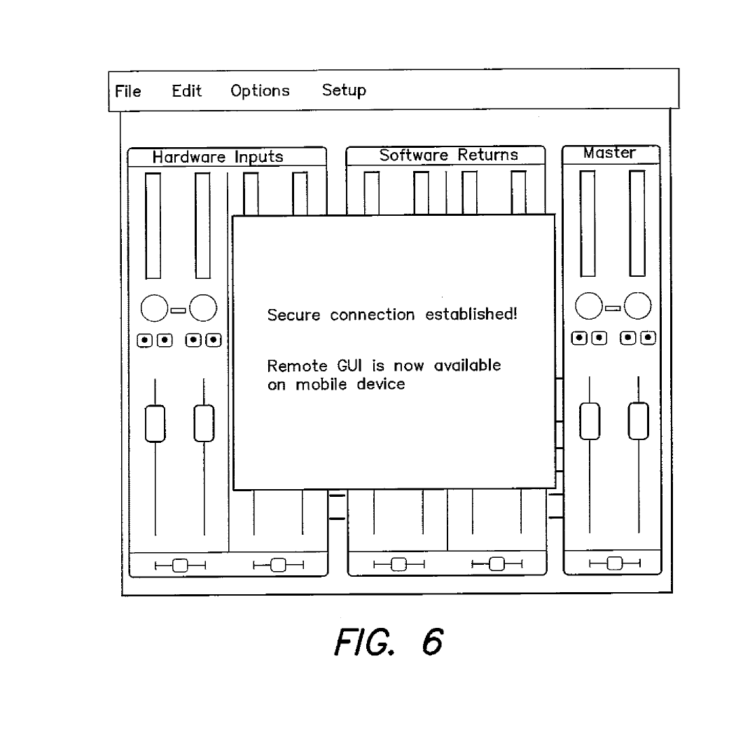

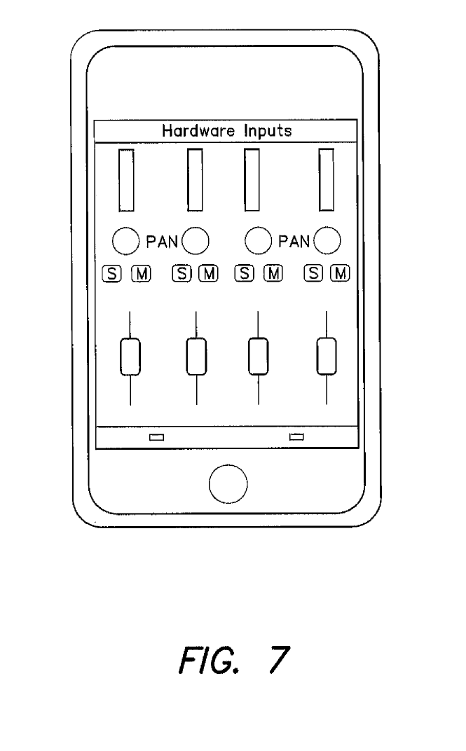

The various steps involved in the process are described using a digital audio workstation (DAW) as an example of the host application. The host machine's user opens up the host application (FIG. 1, 102), and requests a connection to a mobile device (104). This may be done, for example, by selecting a menu item, as depicted in FIG. 2. The request to connect may be an option on a number of different displayed windows of the DAW, and the specific remote interface that is connected may be the one associated with the currently displayed window. In FIG. 2, a mixer window is displayed, and the remote interface being requested corresponds to placing a similar interactive mixer control panel on the remote controller device. Once the request for a remote connection is received, the host application generates a one-time use key and outputs a representation of the key. (FIG. 1, 106, FIG. 3). The key may be represented in the form of a QR code, and output to a display screen of the host machine, as depicted in FIG. 3. The host application also sends the key to a web server (106). The user activates a connection application on the mobile device, which receives the output from the host application. In the example illustrated in FIG. 3, the mobile device receives the output from the host application when the user points the camera of the mobile device towards the host machine's screen (FIG. 4) and captures an image of the QR code displayed on the host application screen (108). An application on the mobile device then processes the received representation of the key, extracts the key from the representation, and uses it to initiate a secure connection via the Web server with the host application (110). In the example illustrated in FIGS. 3-5, the mobile device runs a QR code scanning application, which extracts the one-time use key from the captured image (FIG. 5). The mobile device then uses the key to gain access to a web server, which in turn forwards a request to connect from the mobile device to the host application. The host application detects the mobile device connection request, establishes the connection, and then hides the key (FIG. 1, 112; FIG. 6). Having established the connection, the host application sends to the mobile device information for implementing the remote user interface on the mobile device (114), and the mobile application displays the remote UI (116, FIG. 7). A two-way, interactive remote user interface is now established on the remote device. The entire process takes place without the need for the user to enter an IP address, select a port, or present secure credentials such as a password.

We now describe an exemplary connection process such as the one outlined above in more detail. The process starts with the user of a host application requesting a connection to a mobile device so that an aspect of the user interface of the host application may be placed on a remote device. The remoted UI may be similar to or substantially identical to the host application's UI for a particular functionality, or it may be an adapted version, such as a version with simplified controls suitable for the smaller screen of a mobile device, or be specially adapted for touch input. When the user enters the request, such as by selecting a menu item as illustrated in FIG. 2, the host application enters a listening mode. In this mode, the host application opens up a TCP or UDP port using, for example, UPnP protocols. The necessary exclusions are automatically added via a UPnP service to any firewall that is running on the host machine in order to allow incoming connections. The port is for a web server that listens for the remote connection and authorization information. The host application generates a one-time access key, such, as by using a random number computed internally by the host application. This key serves as the credential to verify that only the intended remote device can connect to the host application. The host application converts the one-time access key into a representation that is suitable for output on an output device available to the host application. It also adds additional information that directs a request from a mobile device to the correct input port. In the described embodiment, the information is displayed as a QR code containing an IP address, port number, and the one-time access key. For example, the QR code may contain the information required to connect to the open port in the form of a URL such as http://servername.com:port/one_time_access_key. The access key may be encrypted, though, depending on the environment in which the connection between the host application and the mobile device is made, there may be no need to use encryption since the access key is randomly generated each time the host application goes into listening mode. Since the key contains a string of randomly generated characters, rather than persistent, confidential credential information such as a user name and password, the key has no purpose other than to effect the one-time connection. In addition to outputting a representation of the access key on an output device, the host application transmits the key to a web server that is to serve as gatekeeper for any remote device seeking a connection to the host application.

Using an internet-connected mobile device that includes a camera, such as a smart phone or tablet, the user opens a QR code scanning application. QR code scanning functionality may be integrated into the mobile device, or a QR code scanning application may be downloaded to the mobile device over the Internet if none is already installed. QR scanning software applications for mobile devices are well known in the art. The mobile device user points the camera of the mobile device at the host machine's screen, and scans the QR code. Other graphical methods of representing the access key may be used. Screen-based representations include, but are not limited to, a bar code, graphical stenographic elements embedded in the host application UI, and alphanumeric text. In each case, the mobile device requires a camera or scanning device and, at least at the time of establishing the connection, a line of sight to the host machine's screen. The mobile device captures an image of the host machine's screen containing the access key, and processes the image to extract the key, using appropriate decoding and detection application software corresponding to the type of graphical representation used for the access key.

The mobile device then uses the extracted access key to establish a network connection to the gateway web server. It achieves this by using the key to access a web page on a web server. The server is able to parse the URL request from the mobile device for the one-time access key. The user is then optionally asked for a session-specific password that serves as a further optional security protocol to facilitate rapid reconnection of a remote device to the host application at a later time while ensuring that only authorized users are able to re-establish a connection, and to enable session-specific access restrictions.

As soon as an initial connection to a remote device via the web server is established, the host application goes out of listening mode. The host application then establishes a secure channel to the mobile device, such as with a transport layer security (TLS) connection. Using the secure channel, it sends the remote UI information to the mobile device. This information includes software and data that enables the mobile device to build and display the remote user interface, which may be implemented as an HTML5 remote GUI. Communication may be performed via a WebSocket back-channel.

A connection is terminated either via the host application or via the remote device. Reconnection of a particular mobile device as a remote control to a given host application may proceed automatically, for example each time the mobile device user re-launches the remote control application and provides an optional session-specific password requested by the host application. Alternatively, a new one-time access key may be required each time a connection is to be made.

Other output modalities may be used to communicate a one-time access key from the host application to the mobile device. For example, the host application may communicate the access key to the mobile device via a watermarked audio signal in which a digital non-audio representation of the access key is embedded in the audio signal. This approach allows the access key to be transmitted via audio in a manner that is resilient to variations in the ambient acoustic environment. The watermarked audio signal is output by a host computer loudspeaker, and a microphone in the mobile device receives the audio. An audio signal analysis application on the mobile device analyzes the audio and extracts the key. The information may be encoded into the host application's standard audio output using spread-spectrum audio watermarking, or it may be encoded using orthogonal frequency division multiplexing as a signal to be transmitted by the host application on its own. This audio output modality requires that the mobile device be in listening range of the host machine's output speaker, which may involve a physical proximity constraint and a limit on the amount of ambient sound, at least at the frequencies that contain the key information in the audio signal. However, the audio output modality does not, require a line of sight between the host computer and the mobile device.

One technique for embedding the access key into an audio signal involves the following. A piece of data is encoded as a kernel audio signal, which is created by adding a single-sample Dirac delta function to a low-level delayed pseudo-random signal that contains the access key data to be encoded. The kernel signal is convolved with the original output from the host application to produce a time-spread echo-hidden signal. This watermarked signal remains perceptually similar to the original signal, and is output by the host application. The mobile device uses its on-board microphone input to analyze the signal. By taking the cepstrum of the received signal, it is possible to discover the specific parameters of the watermark, and extract the pseudo-random signal. Error correction bits are included in the encoded signal to enable key extraction even under poor transmission conditions, such with ambient noise, or variable received volume.

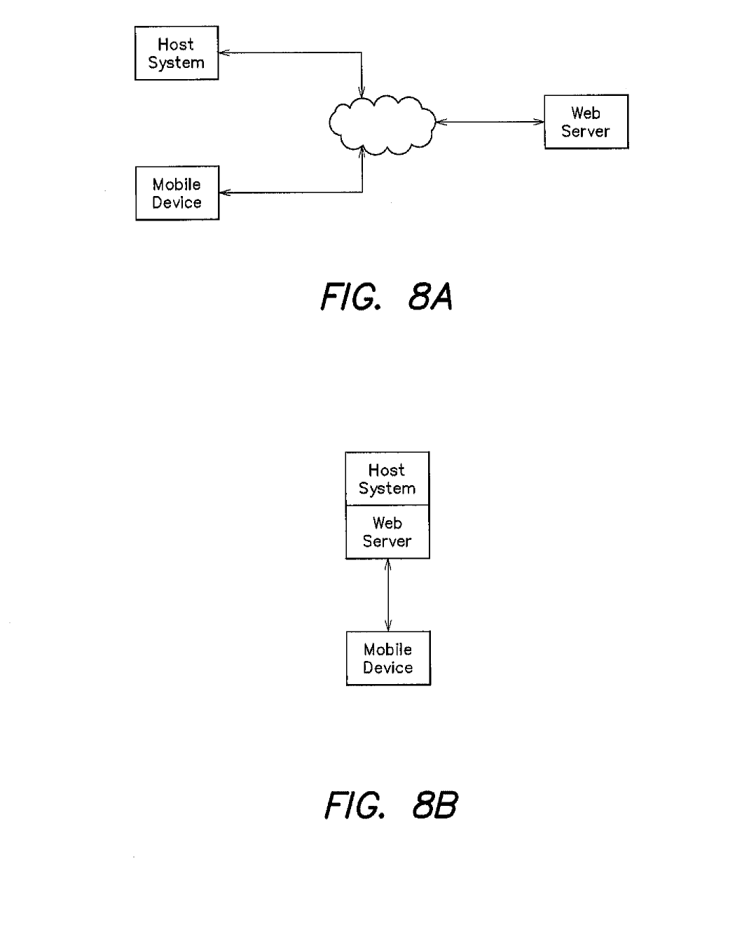

The web server may be located remotely from the mobile device and host machine, and connect to them via a network such as the Internet, as illustrated in FIG. 8A. In this architecture, the remote UI communication between the mobile device and the host application goes via the web server. An advantage of keeping the web server separate from the host application is that it allows connections between multiple remote controls and multiple host applications to be managed by a centralized server, which reduces the performance overhead of the machine running the host application. In an alternative embodiment the web server is hosted on the host machine, as shown in FIG. 8B. The web server may be embedded within the application for which a remote UI is requested. In the case of a web server hosted on the host machine, the connection that is established between the mobile device and the host application is implemented as a wireless connection that goes straight from the mobile device to the host machine, such as via a WiFi or Bluetooth connection. This architecture has the advantage of only requiring LAN access to facilitate remote GUIs without the need for the Internet connection that would be required to connect via a centralized web server.

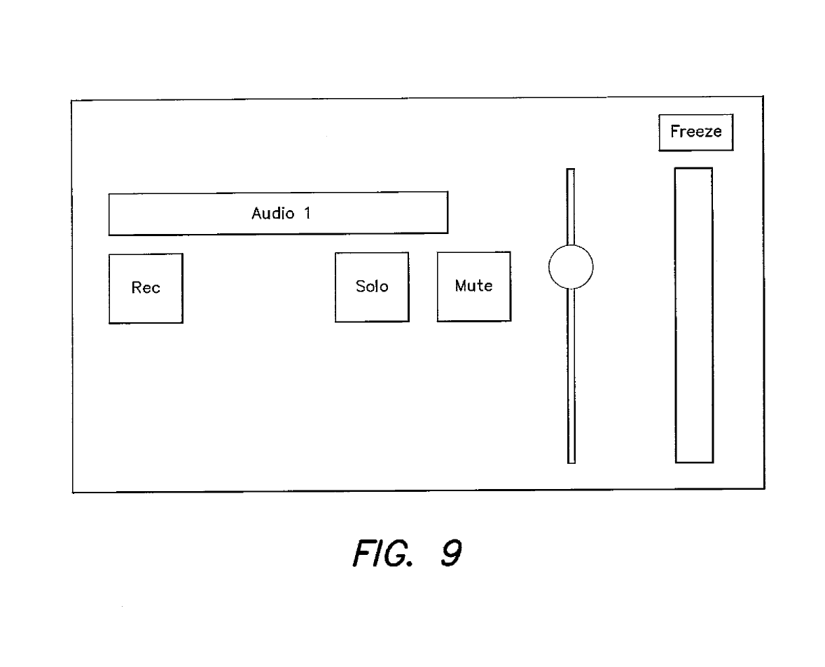

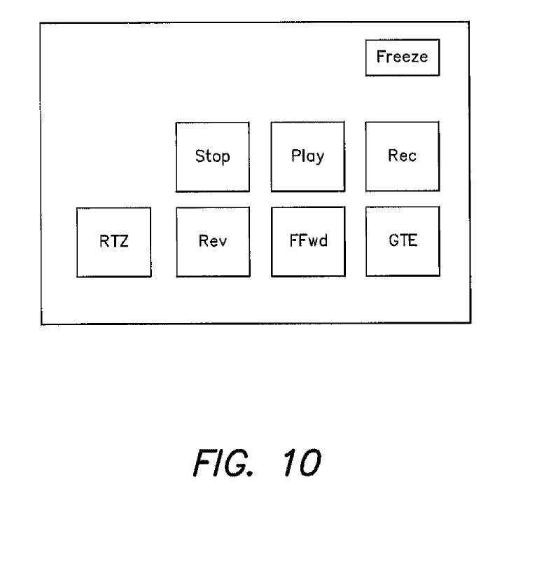

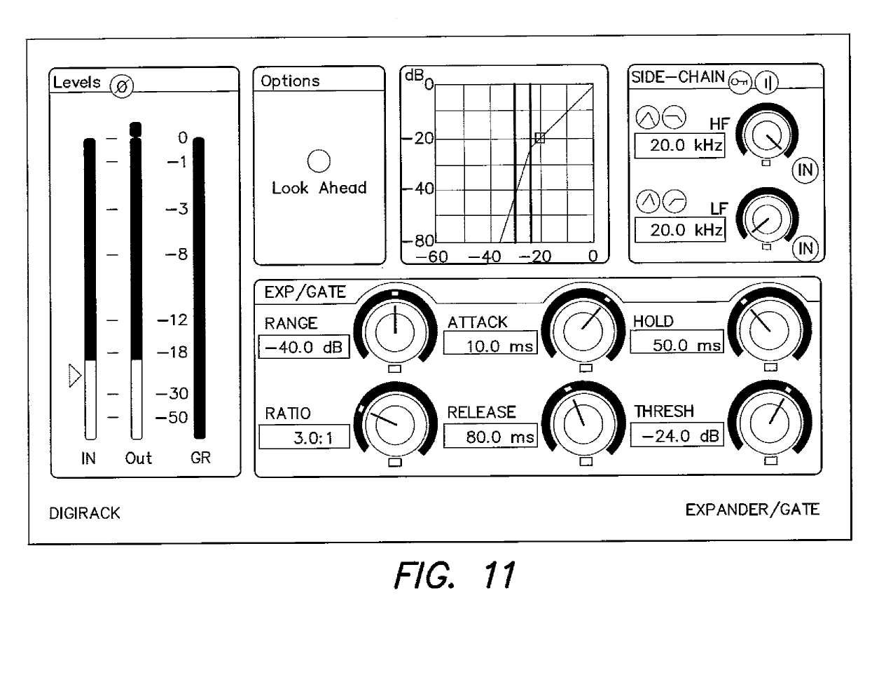

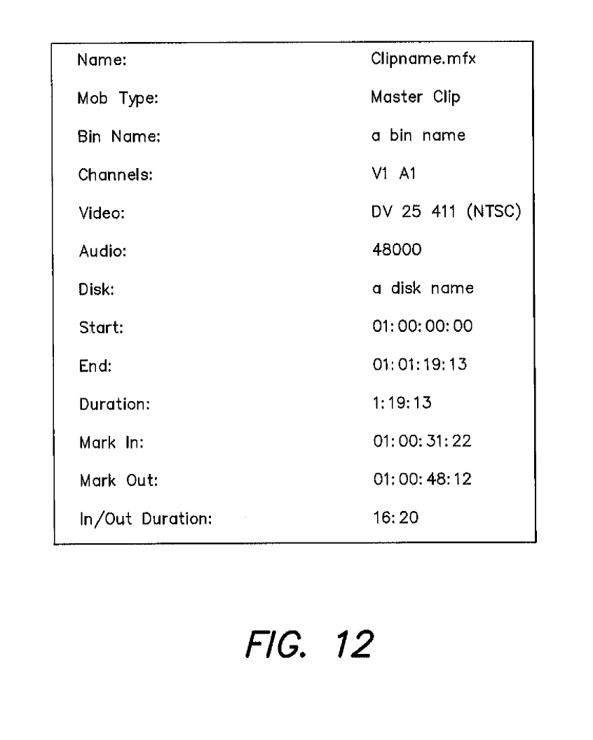

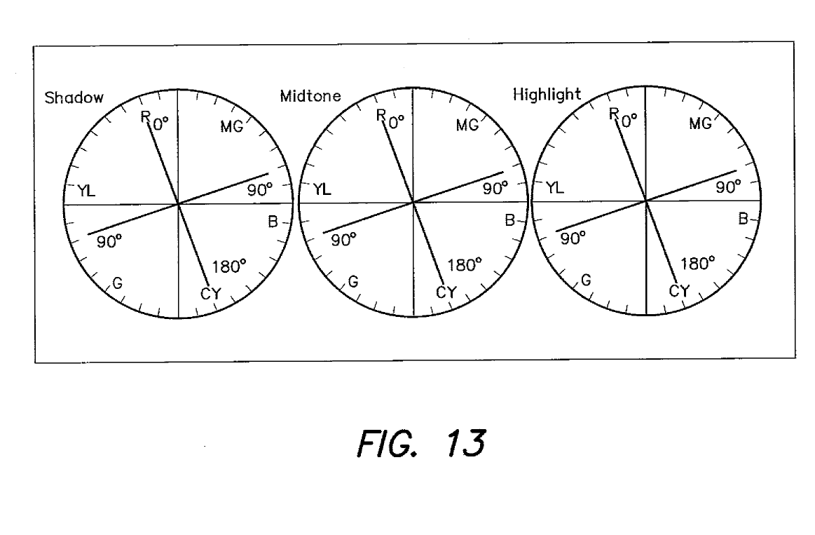

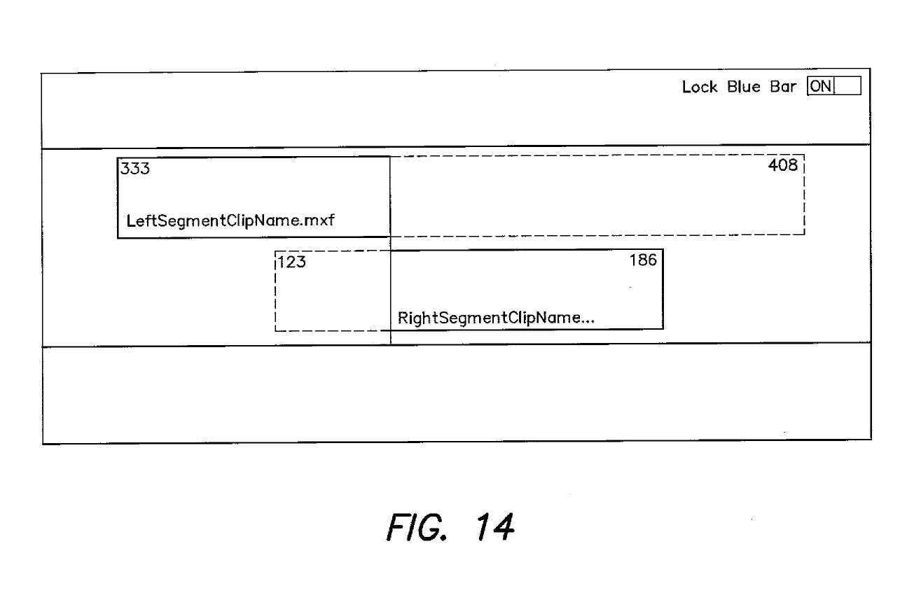

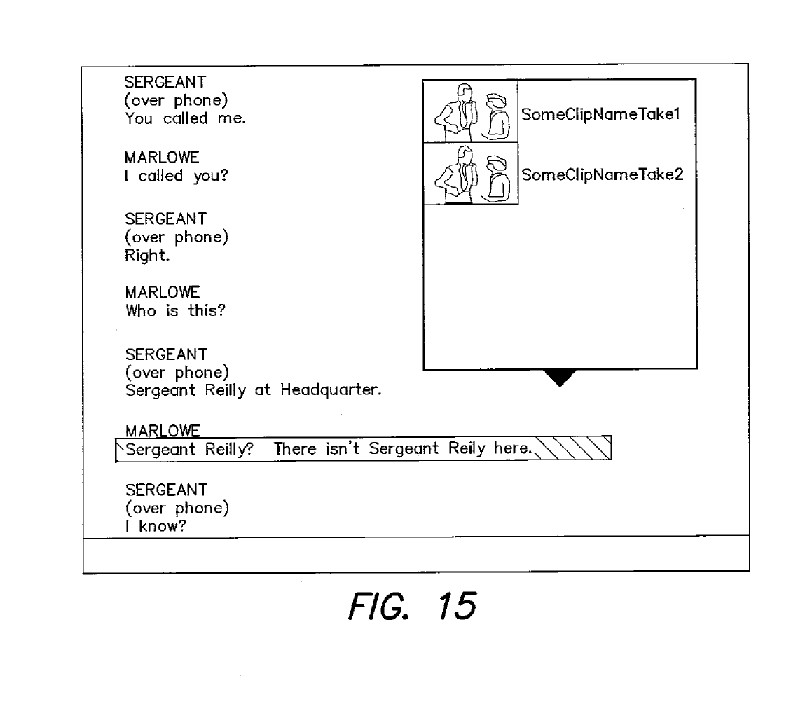

As mentioned above, complex interfaces that may benefit from remote controls often arise in media composition applications, and especially when working with time-based media such as video and audio. For example, for editing audio with digital audio workstations such as PRO TOOLS® available from Avid Technology, Inc. of Burlington, Mass., user interfaces that may be remoted via a connection to a mobile device include, but are not limited to mixer controls (FIG. 7), channel controls (FIG. 9), transport bar (FIG. 10), and plug-in LTIs, such as for a compressor limiter plug-in (FIG. 11). For video composition and editing applications, such as MEDIA COMPOSER® available from Avid Technology, Inc., user interfaces on a remote mobile device include, but are not limited to a bin window (FIG. 12), color controls (FIG. 13), a timeline in trim mode (FIG. 14), and a script view with search controls (FIG. 15).

Other suitable applications for connecting a mobile device for remote control include interfaces for embedded products such as instrument synthesizers, live sound consoles, and audio and video I/O peripherals, such as ELEVEN RACK®, VENUE SC48 console, and the Avid 003 family of audio interfaces, all available from Avid Technology, Inc.,

The mobile device includes a memory, a memory controller, one or more processing units (CPU's), a peripherals interface, RF circuitry, optionally audio circuitry and a speaker and microphone, an input/output (I/O) subsystem, a touch screen, other input or control devices, and an external port. These components communicate over the one or more communication buses or signal lines. The device can be any portable electronic device, including but not limited to a handheld computer, a tablet computer, a mobile phone, a media player, a personal digital assistant (PDA), or the like, including a combination of two or more of these items. The various components of the mobile device may be implemented in hardware, software or a combination of both hardware and software, including one or more signal processing and/or application specific integrated circuits.

The memory may include high speed random access memory and may also include non-volatile memory, such as one or more magnetic disk storage devices, flash memory devices, or other non-volatile solid state memory devices. In some embodiments, the memory may further include storage remotely located from the one or more processors, for instance network attached storage accessed via the RF circuitry or external port and a communications network (not shown) such as the Internet, intranet(s), Local Area Networks (LANs), Wide Local Area Networks (WLANs), Storage Area Networks (SANS) and the like, or any suitable combination thereof. Access to the memory by other components of the device, such as the CPU and the peripherals interface, may be controlled by the memory controller.

The peripherals interface couples the input and output peripherals of the device to the CPU and the memory. The one or more processors run various software programs and/or sets of instructions stored in the memory to perform various functions for the device 100 and to process data.

In some embodiments, the peripherals interface, the CPU, and the memory controller may be implemented on a single chip. In some other embodiments, they may be implemented on separate chips.

The RF (radio frequency) circuitry receives and sends electromagnetic waves. The RE circuitry converts electrical signals to/from electromagnetic waves and communicates with communications networks and other communications devices via the electromagnetic waves. The RF circuitry may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RE circuitry may communicate with the networks, such as the Internet, also referred to as the World Wide Web (WWW), an Intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS)), or any other suitable communication protocol, including communication protocols not yet developed as of the filing date of this document.

The audio circuitry, the speaker, and the microphone provide an audio interface between a user and the device, and may also provide a communications channel between the device and the host computer for exchange of an access key and other information. The audio circuitry receives audio data from the peripherals interface, converts the audio data to an electrical signal, and transmits the electrical signal to the speaker. The speaker converts the electrical signal to human-audible sound waves. The audio circuitry also receives electrical signals converted by the microphone from sound waves. The audio circuitry converts the electrical signal to audio data and transmits the audio data to the peripherals interface for processing. Audio data may be may be retrieved from and/or transmitted to the memory and/or the RF circuitry by the peripherals interface 108. In some embodiments, the audio circuitry also includes a headset jack (not shown). The headset jack provides an interface between the audio circuitry and removable audio input/output peripherals, such as output-only headphones or a headset with both output (headphone for one or both ears) and input (microphone).

The I/O subsystem provides the interface between input/output peripherals on the device, such as the touch screen and other input/control devices, and the peripherals interface. The I/O subsystem includes a touch-screen controller and one or more input controllers for other input or control devices. The one or more input controllers receive/send electrical signals from/to other input or control devices. The other input/control devices may include physical buttons (e.g., push buttons, rocker buttons, etc.), dials, slider switches, sticks, and so forth.

The touch screen provides both an output interface and an input interface between the device and a user. The touch-screen controller receives/sends electrical signals from/to the touch screen. The touch screen displays visual output to the user. The visual output may include text, graphics, video, and any combination thereof. Some or all of the visual output may correspond to user-interface objects, further details of which are described below.

The touch screen may use LCD (liquid crystal display) technology, or LPD (light emitting polymer display) technology, although other display technologies may be used in other embodiments. The touch screen and touch screen controller may detect contact and any movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

The mobile device also includes a power system for powering the various components. The power system may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

In some embodiments, the software components include an operating system, a communication module (or set of instructions), a graphics module (or set of instructions), a user interface state module (or set of instructions), and one or more applications (or set of instructions).

The communication module facilitates communication with other devices over one or more external ports and also includes various software components for handling data received by the RF circuitry 112 and/or the external port. The external port (e.g., Universal Serial Bus (USB), FIREWIRE, etc.) is adapted for coupling directly to other devices or indirectly over a network (e.g., the Internet, wireless LAN, etc.).

The various components of the host system described herein may be implemented as a computer program using a general-purpose computer system. Such a computer system typically includes a main unit connected to both an output device that displays information to a user and an input device that receives input from a user. The main unit generally includes a processor connected to a memory system via an interconnection mechanism. The input device and output device also are connected to the processor and memory system via the interconnection mechanism.

One or more output devices may be connected to the computer system. Example output devices include, but are not limited to, liquid crystal displays (LCD), plasma displays, touch screens, various stereoscopic displays including displays requiring viewer glasses and glasses-free displays, cathode ray tubes, video projection systems and other video output devices, printers, devices for communicating over a low or high bandwidth network, including network interface devices, cable modems, and storage devices such as disk or tape. One or more input devices may be connected to the computer system. Example input devices include, but are not limited to, a keyboard, keypad, trackball, mouse, pen and tablet, touchscreen, camera, communication device, and data input devices. The invention is not limited to the particular input or output devices used in combination with the computer system or to those described herein.

The computer system may be a general purpose computer system which is programmable using a computer programming language, a scripting language or even assembly language. The computer system may also be specially programmed, special purpose hardware. In a general-purpose computer system, the processor is typically a commercially available processor. The general-purpose computer also typically has an operating system, which controls the execution of other computer programs and provides scheduling, debugging, input/output control, accounting, compilation, storage assignment, data management and memory management, and communication control and related services. The computer system may be connected to a local network and/or to a wide area network, such as the Internet. The connected network may transfer to and from the computer system program instructions for execution on the computer, media data such as video data, still image data, or audio data, metadata, review and approval information for a media composition, media annotations, and other data.

A memory system typically includes a computer readable medium. The medium may be volatile or nonvolatile, writeable or nonwriteable, and/or rewriteable or not rewriteable. A memory system typically stores data in binary form. Such data may define an application program to be executed by the microprocessor, or information stored on the disk to be processed by the application program. The invention is not limited to a particular memory system. Time-based media may be stored on and input from magnetic, optical, or solid state drives, which may include an array of local or network attached disks.

A system such as described herein may be implemented in software or hardware or firmware, or a combination of the three. The various elements of the system, either individually or in combination may be implemented as one or more computer program products in which computer program instructions are stored on a non-transitory computer readable medium for execution by a computer, or transferred to a computer system via a connected local area or wide area network. Various steps of a process may be performed by a computer executing such computer program instructions. The computer system may be a multiprocessor computer system or may include multiple computers connected over a computer network. The components described herein may be separate modules of a computer program, or may be separate computer programs, which may be operable on separate computers. The data produced by these components may be stored in a memory system or transmitted between computer systems.

Having now described an example embodiment, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention.

What is claimed is:

1. A method of connecting a mobile device to a host application running on a host computer, the method comprising:
in response to receiving a request from a user of the host application to connect the host application to the mobile device:
causing the host application to:
generate an access key;
transmit the access key to a web server in data communication with the host computer;
output a representation of the access key on an output device of the host computer; and
transition to a listening mode;
enabling the host application to receive via the web server, a request from the mobile device to connect to the host application, wherein the mobile device gains access to the web server by:
capturing the representation of the access key from the output device;
extracting the access key from the captured representation of the access key; and
presenting the access key to the web server; and
in response to receiving via the web server the request from the mobile device to connect to the host application, establishing a connection between the host application and the mobile device via the web server.

2. The method of claim 1, further comprising:
receiving at the host computer via the connection identification information for a user of the mobile device; and
if the identification information does not correspond to an authorized mobile device user, closing the connection between the computer and the mobile device.

3. The method of claim 1, wherein the output device is a display screen, and wherein capturing the representation of the access key includes capturing an image of the display screen using a camera in the mobile device.

4. The method of claim 1, wherein the key is displayed as a QR code, and the key is extracted by a QR code reader application on the mobile device.

5. The method of claim 1, wherein the key is dynamically generated by the host computer.

6. The method of claim 1, wherein the host computer hosts an application and further comprising sending over the connection from the host computer to the mobile device information that enables the mobile device to act as a remote control device for the application.

7. The method of claim 6, wherein the application is a time-based media editing application, and wherein enabling the mobile device to act as a remote control device includes enabling the mobile device to act as at least one of transport controls, a mixer, a user interface for a plug-in to the time-based media composition application, and a user interface for controlling parameters of a time-based media composition.

8. The method of claim 7, wherein the parameters of the time-based media composition include audio track volume, audio track pan, audio track I/O routing, and an application status panel.

9. The method of claim 6 wherein, when the mobile device acts as a remote control device, control information is sent over the connection from the mobile device to the application and status information is sent from the application to the mobile device.

10. The method of claim 1, wherein the web server is hosted by the host computer, and the connection between the host computer and the mobile device is a wireless connection.

11. The method of claim 1, wherein the output device is an audio output device, and wherein capturing the representation of the access key includes using a microphone in the mobile device to capture audio that is output by the audio output device.

12. The method of claim 11, wherein the representation of the access key is embedded as a watermark signal in the audio that is output by the audio output device.

13. A method of connecting a mobile device to a host application running on a host computer, the method comprising:
capturing on the mobile device a representation of an access key from an output device of the host computer, wherein, in response to the host application receiving a request from a user of the host application to connect the mobile device to the host application, the host application:
generates the access key;
transmits the access key to a web server in data communication with the host computer; and
outputs the representation of the access key on the output device of the host computer;
using the mobile device to:
extract the access key from the captured representation of the access key;
access the web server by presenting the access key to the web server; and
request a connection to the host application via the web server; and
connecting the mobile device to the host application via the web server, wherein the host application establishes a connection with the mobile device in response to receiving via the web server the request from the mobile device to connect to the host application.

14. A computer program product comprising:
a computer-readable medium with computer program instructions encoded thereon, wherein the computer program instructions, when executed by a host computer, instruct the host computer to perform a method of connecting a mobile device to a host application running on the host computer, the method comprising:
in response to receiving a request from a user of the host application to connect the host application to the mobile device:
causing the host application to:
generate an access key;
transmit the access key to a web server in data communication with the host computer;
output a representation of the access key on an output device of the host computer; and
transition to a listening mode;
enabling the host application to receive via the web server, a request from the mobile device to connect to the host application, wherein the mobile device gains access to the web server by:
capturing the representation of the access key from the output device;
extracting the access key from the captured representation of the access key; and
presenting the access key to the web server; and
in response to receiving via the web server the request from the mobile device to connect to the host application, establishing a connection between the host application and the mobile device via the web server.

15. A computer system comprising:
an output device;
a memory for storing computer-readable instructions for executing a host application; and
a processor in data communication with the output device and with the memory, wherein the processor, when executing the computer-readable instructions, causes the host application to respond to receiving a request from a user of the host application to connect the host application to a mobile device by:
generating an access key;
transmitting the access key to a web server in data communication with the host computer;
outputting a representation of the access key on an output device of the host computer;
transitioning to a listening mode;
enabling the host application to receive via the web server, a request from the mobile device to connect to the host application, wherein the mobile device gains access to the web server by:
capturing the representation of the access key from the output device;
extracting the access key from the captured representation of the access key; and
presenting the access key to the web server; and
in response to receiving via the web server the request from the mobile device to connect to the host application, establishing a connection between the host application and the mobile device via the web server.

16. The computer system of claim 15, wherein the host application is a time-based media editing application.

17. The computer system of claim 15, wherein the output device is a display screen and the access key is graphically encoded.

18. The computer system of claim 17, wherein the access key is encoded as a QR code.

19. The computer system of claim 15, further comprising using the connection between the host application and the mobile device to transmit information from the host application to the mobile device, wherein the information includes instructions that, when executed on the mobile device, cause the mobile device to act as a remote user interface for the host application.

20. The computer system of claim 15, wherein the output device is an audio output device, and the access key is acoustically encoded.
